(19) United States
(12) Patent Application Publication
(10) Pub. No.: US 2024/0428184 A1
(43) Pub. Date: Dec. 26, 2024

(54) COMPUTER VISION BASED INVENTORY SYSTEM AT INDUSTRIAL PLANTS

(71) Applicant: eMeasurematics Inc., Chicago, IL (US)

(72) Inventor: Mudrad Guhya, Chicago, IL (US)

(21) Appl. No.: 18/339,843

(22) Filed: Jun. 22, 2023

(51) Int. Cl. G06Q 10/087; G06N 3/08

(52) U.S. Cl. CPC G06Q 10/087; G06N 3/08

(57) ABSTRACT

Systems and methods for inventory management at a facility. One system includes a central management server including a camera system, a transceiver, and an electronic processor. The electronic processor is configured to receive, via the transceiver, identification information for a product, identify an initial location of the product within the facility and a target location to move the product to within the facility based on the identification information, and perform, via a vehicle configured to handle the product, and verify a transaction of the product between the initial location and the target location based on image data from the camera system. The electronic processor is further configured to verify the transaction based on image data from the camera system and generate, based on the image data from the camera system, a chain of custody record for the product.

### FIELD OF THE INVENTION

The present application relates to computer vision and inventory management system at industrial plants, marine terminals, intermodal yards and large warehouses, for example, steel-making plants, container handling yards, distribution center.

### BRIEF DESCRIPTION OF THE DRAWINGS

FIG. 1 is a block diagram of an inventory management system in accordance with some embodiments.

FIG. 2 is a block diagram of a central management server of the inventory management system of FIG. 1 in accordance with some embodiments.

FIG. 3 illustrates an inventory location of FIG. 1 in accordance with some embodiments.

FIG. 4 illustrates an inventory location of FIG. 1 in accordance with some embodiments.

FIG. 5 is a block diagram of an inventory location console of the inventory management system of FIG. 1 in accordance with some embodiments.

FIG. 6 is a block diagram of an in-vehicle console of the inventory management system of FIG. 1 in accordance with some embodiments.

FIG. 7 is a flowchart of a method for computer-vision based inventory management at an industrial plant in accordance with some embodiments.

FIG. 8 is a flowchart of a method for verifying inventory item transaction at an inventory location in accordance with some embodiments.

FIG. 9 is a flowchart of a method for vehicle dispatch to inventory location in accordance with some embodiments.

FIG. 10 is a flowchart of a method for training a location prediction application.

FIG. 11 is a flowchart of a method for enabling and using a location prediction application.

### DETAILED DESCRIPTION

Before any embodiments are explained in detail, it is to be understood that the embodiments are not limited in its application to the details of construction and the arrangement of components set forth in the following description or illustrated in the following drawings. Other embodiments are possible and embodiments described and/or illustrated herein are capable of being practiced or of being carried out in various ways.

It should be understood that although certain drawings illustrate hardware and software located within particular devices, these depictions are for illustrative purposes only. In some embodiments, the illustrated components may be combined or divided into separate software, firmware and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links.

In most steel-making plants, steel is manufactured according to buyer specifications providing for a specific composition and type. Steel may be produced in slabs, sheets, coils, structural steel and the like and is transported within the steel-making plant between various locations. For example, steel inventory may be transported from the manufacturing facility to a warehouse lot or an outdoor lot and from the warehouse lot or the outdoor lot to a rail yard where the inventory is loaded onto transport vehicles for delivery to buyers. Inventory may be transported between various locations using manually-operated, semi-autonomous, and autonomous vehicles. In a marine terminal, shipping containers are similarly transported between a shipping vessel, an outdoor lot, and transportation vehicles (e.g., trains, trucks, and the like). In the following description and claims, the term industrial plant is used to refer to industrial plants such as steel-making plants, marine terminals, intermodal yards, large warehouses, and the like.

Inventory is stamped or embedded with identification information after manufacturing or packing. The identification information is used to track inventory between the different locations within the industrial plant. Typically, inventory is manually tracked by employees of the industrial plant. The employees scan the inventory and manually enter the information regarding the location of the inventory into an inventory management system. However, there is no independent means to verify location of pick-ups and drop-offs of inventory and the number of inventory handled.

Currently, verification and inventory management systems include indirect methods such as Global Positioning System (GPS) positioning, sensor based positioning systems (for example, equipment moving steel is equipped with X, Y, and Z a coordinate location system, within buildings or outside open yards), weight measurements, and operator input. However, these verification and inventory systems are prone to operator error and/or equipment failure and often provide inaccurate inventory information. Additionally, there are limited ways to identify when the sensors are beginning to function inaccurately and an operator may only notice the sensor inaccuracy late in or even after fulfilling an order. Small errors may propagate and contaminate the rest of the inventory data leading to diminished certainty or overall inventory tracking failure.

One advancement to be made involves applying a location prediction application based on machine learning. Such an application could be implemented on a deep learning module coupled to a central server of an inventory management system. By using cameras mounted on vehicles, a fully trained location prediction application could identify various inventory items and determine the locations of said inventory items within the industrial plant, and track the locations of said inventory items in the inventory management system. Employing an application such as this would eliminate the need for employees to scan the inventory items and manually enter the information regarding the location of the inventory into the inventory management system. Additionally, employing an application such as this would provide an independent means to verify location of pick-ups and drop-offs of inventory and the number of inventory items handled. The location prediction application may also be used to fully automate the transportation vehicles. In general, these improvements would lead to less errors in inventory management system associated with human error.

For example, most steel-making plants include Electric Overhead Transport (EOT) cranes and most marine terminals include Rubber-Tyre (or Rail-Mounted) Gantry (RTG) cranes. EOT cranes run on rails at a suitable height above a yard. EOT cranes are used to transport steel articles, such as ladles of molten metal or fabricated steel products (e.g., slabs, sheets, rolls, and the like). Traditionally, EOT cranes have a human operator who is responsible for visually identifying the steel articles and move them from a first location within the yard to a second location within the yard. Alternatively, the operator may be responsible for moving the steel articles from a location within the yard to another piece of transport equipment, such as rail cars or trucks.

In some cases, EOT cranes may be equipped with cameras, and linked to a central inventory management server employing a deep learning module. The deep learning module may be configured to run a location prediction application. To train the location prediction application, an EOT crane may be equipped with a temporary sensor-based positioning system to identify the X, Y, and Z position of the EOT crane within a coordinate location system of the yard. The identified position information of the EOT crane may be used to train the location prediction application. Once the location prediction application has been adequately trained, the temporary sensor-based positioning system may be removed from the EOT crane, and the EOT crane will be able to autonomously determine inventory items and the locations of said inventory items based on camera input alone.

Accordingly, there is a need for an accurate inventory management system that automatically tracks inventory across various locations and provides avenues for automatically resolving discrepancies.

One embodiment provides a central management server including a memory storing an inventory database, a transceiver for communication with one or more of an inventory location console and a vehicle console, and an electronic processor coupled to the memory and the transceiver. The electronic processor is configured to receive identification information for product manufactured to customer specifications and populate inventory information for the product based on identification information. The electronic processor is also configured to move the product between one or more of a manufacturing location, intermediate storage location and delivery location and verify product transactions using camera systems at one or more of the inventory location console and the vehicle console. The electronic processor is also configured to perform chain of custody corrections and generate chain of custody record for the product.

Another embodiment provides a method for computer-vision based inventory management at an industrial plant including receiving identification information for product manufactured to customer specifications and populating inventory information for the product based on identification information. The method also includes moving the product between one or more of a manufacturing location, intermediate storage location and delivery location and verifying product transactions using camera systems at one or more of the inventory location console and the vehicle console. The method further includes performing chain of custody corrections and generating chain of custody record for the product.

Another embodiment provides a method for verifying product transaction at an inventory location. The method includes identifying a vehicle performing product transaction and identifying an inventory location associated with the product transaction. The method also includes capturing images of the product transaction and providing the images of the product transaction to a central management server. The method also includes processing images for product transaction verification.

Another embodiment provides a method for vehicle dispatch to inventory location. The method includes receiving product transaction information and operating a vehicle in along a predetermined route to an inventory location. The method also includes identifying inventory location associated with product transaction and performing the product transaction. The method also includes capturing images of the product transaction and providing images of product transaction to central management server.

Another embodiment provides a method for training a location prediction application of a deep learning module. The method includes receiving, at the deep learning module, location data from one or more location sensors and receiving, at the deep learning module, image data from one or more cameras. The method also includes applying a location prediction application to generate a predicted location of an inventory item or transaction based on the image data. The method further includes determining an actual location of the inventory item or transaction based on the location data. The method also includes comparing the predicted location and the actual location, and updating the location prediction application based on the comparison of the predicted location and the actual location.

Another embodiment provides a method for enabling and using a location prediction application of a deep learning module. The method includes placing one or more temporary location sensors on one or more consoles during a training phase of the location prediction application. The method also includes training the location prediction application by using location data received from the one or more temporary location sensors. The method also includes removing the one or more location sensors from the one or more consoles following a completion of the training phase. The method also includes applying the location prediction application to determine the location of an inventory item or transaction.

Although an example of a steel-making plant is provided, one of ordinary skill in the art will appreciate that the below description is also applicable in other industrial plants where accurate inventory management is desired.

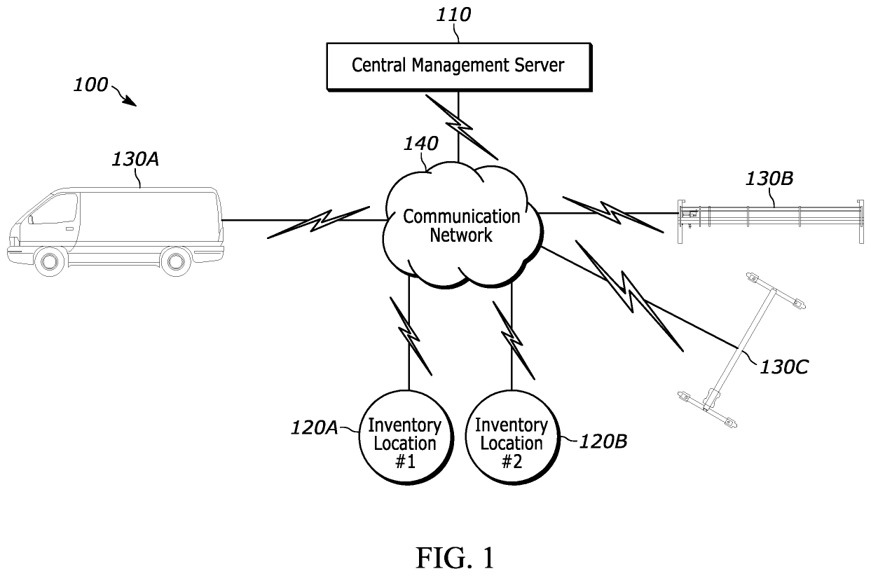

FIG. 1 is a simplified block diagram of an inventory management system 100. In the example illustrated, the inventory management system 100 includes a central management server 110, a plurality of inventory location consoles 120 (for example, a first inventory location console 120A and a second inventory location console 120B), a plurality of vehicle consoles 130 (for example, a first vehicle console 130A, a second vehicle console 130B, and a third vehicle console 130C). FIG. 1 illustrates two inventory location consoles 120A and 120B and three vehicle consoles 130A and 130B, however, one of ordinary skill in the art would appreciate that the inventory management system 100 may be expanded to cover a different number of inventory location consoles 120 and vehicle consoles 130. The central management server 110, the plurality of inventory location consoles 120, and the plurality of vehicle consoles 130 communicate over a communication network 140. The communication network 140 is, for example, a WiFi® network, a cellular network, or the like, or a combination of one or more wired networks and/or one or more wireless networks.

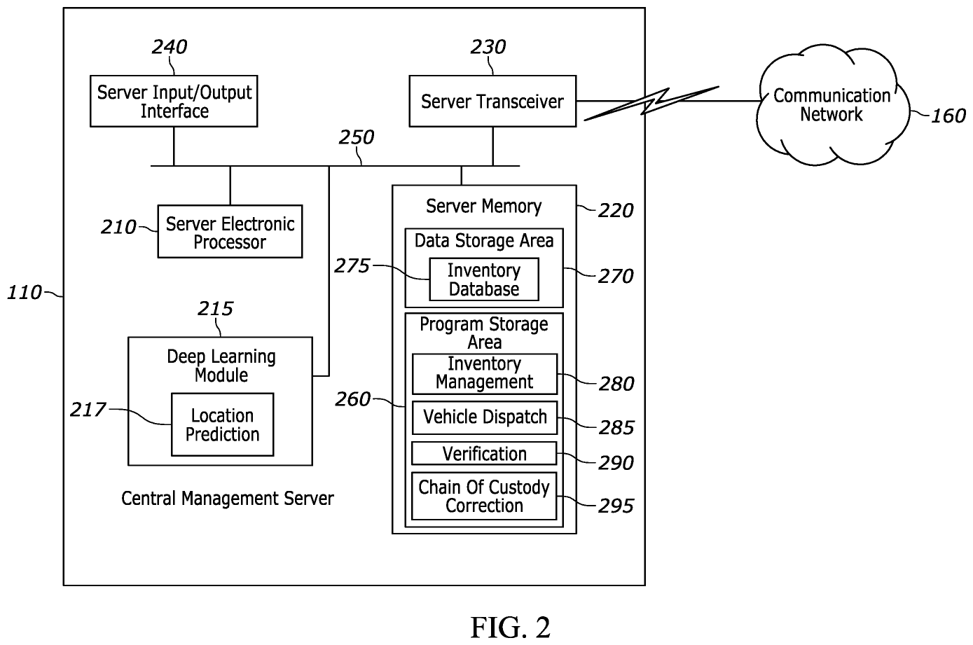

The central management server 110 is a physical or cloud-based server that tracks the inventory of the industrial plant having the inventory management system 100. Referring to FIG. 2, the central management server 110 includes a server electronic processor 210, a deep learning module 215, a server memory 220, a server transceiver 230, and a server input/output interface 240 communicating over one or more control and/or data buses (for example, a server communication bus 250). In some embodiments, the server electronic processor 210 is implemented as a microprocessor with separate memory, such as the server memory 220. In other embodiments, the server electronic processor 210 may be implemented as a microcontroller (with server memory 220 on the same chip). In other embodiments, the server electronic processor 210 may be implemented using multiple processors. In addition, the server electronic processor 210 may be implemented partially or entirely as, for example, a field-programmable gate array (FPGA), an application specific integrated circuit (ASIC), and the like and the server memory 220 may not be needed or be modified accordingly. In the example illustrated, the server memory 220 includes non-transitory, computer-readable memory that stores instructions that are received and executed by the server electronic processor 210 to carry out the functionality of the central management server 110 described herein. In some embodiments, the central management server 110 may include one server electronic processor 210 and/or a plurality of server electronic processors 210 in a cloud computer cluster arrangement, one or more of which may be executing none, all, or a portion of the applications of the central management server 110 provided below, sequentially or in parallel across the one or more server electronic processors 210. The one or more server electronic processor 210 comprising the central management server 110 may be geographically co-located or may be separated by inches, meters, kilometers, or miles, and interconnected via electronic and/or optical interconnects. One or more proxy servers or load balancing server may control which one or more server electronic processors 210 perform any part or all the applications provided below.

The deep learning module 215 may include one or more applications to learn information relating to the working area of the inventory management system 100. In some embodiments, the deep learning module 215 receives inventory location information and/or image data from one or more of the inventory location consoles 120. In some embodiments, the deep learning module 215 receives vehicle location information and/or image data from one or more vehicle consoles 130. The deep learning module 215 may be implemented using, for example, a neural network processor to train based on the data received from the various sensors and cameras described herein. The deep learning module 215 may be provided by a cloud services provider and may include third party provided functions and applications. The deep learning module 215 also stores a location prediction application 217. The deep learning module 215 and/or the server electronic processor 210 execute the location prediction application 217 to determine a location of an inventory item or a vehicle as further described below.

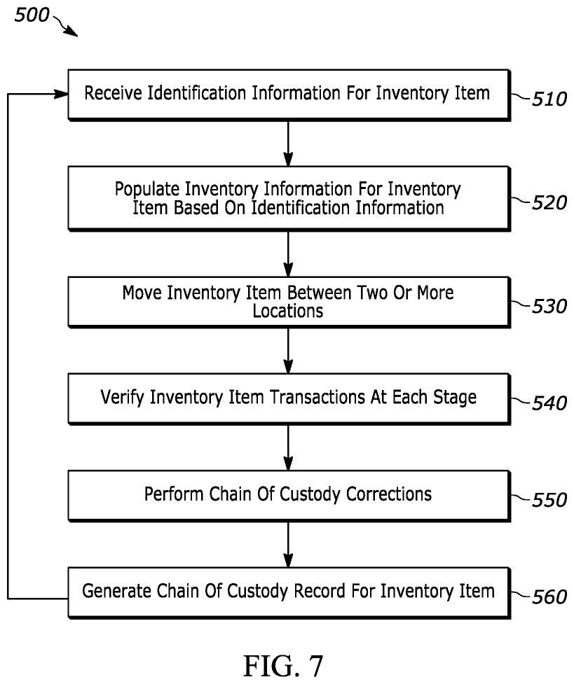

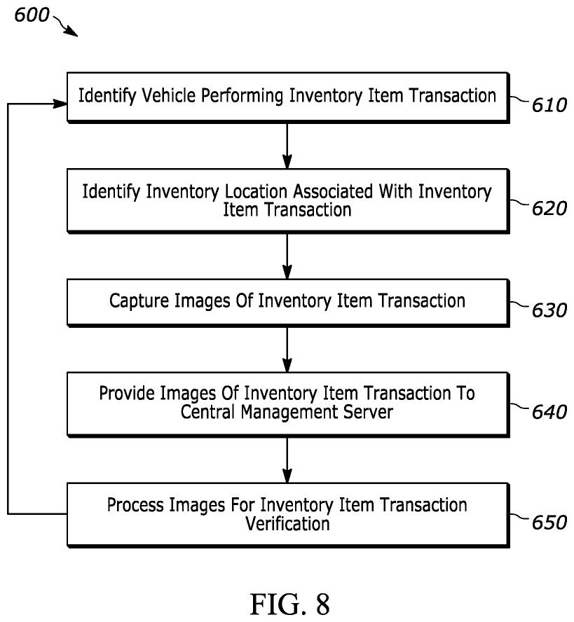

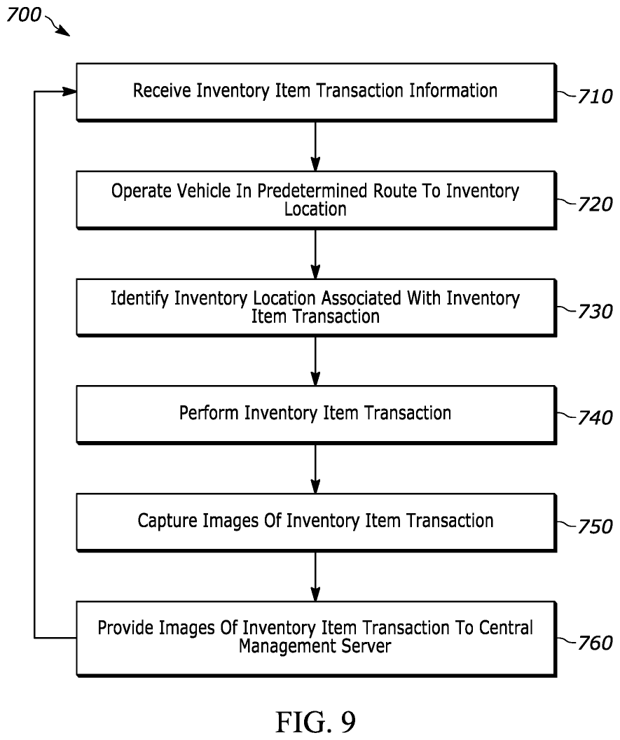

The server memory 220 may include, for example, a program storage area 260 and a data storage area 270. The program storage area 260 and the data storage area 270 may include combinations of different types of memory, such as read-only memory (ROM) and random-access memory (RAM). Similar to the server electronic processor 210, the server memory 220 may be in a cloud cluster arrangement and may be geographically co-located or may be separated and interconnected via electronic and/or optical interconnects. In the example, the data storage area 270 includes an inventory database 275 that includes information regarding the inventory manufactured by the industrial plant. The program storage area 260 includes an inventory management application 280, a vehicle dispatch application 285 (e.g., FIG. 9), a verification application 290 (e.g., FIGS. 8 and 9), and a chain of custody correction application 295 (e.g., FIGS. 8 and 9). The server electronic processor 210 executes the inventory management application 280 to log and track inventory in the inventory database 275 (e.g., FIG. 7). The server electronic processor 210 executes the vehicle dispatch application 285 to dispatch vehicles to perform product transactions (e.g., FIG. 9). The server electronic processor 210 executes the verification application 290 to verify product transactions (e.g., FIGS. 8 and 9). The server electronic processor 210 executes the chain of custody correction application 295 to correct errors in storage of inventory (e.g., FIGS. 8 and 9).

The server transceiver 230 enables wired and/or wireless communication between the central management server 110 and the plurality of inventory location consoles 120, and the plurality of vehicle consoles 130 over the communication network 140. In some embodiments, the server transceiver 230 may comprise separate transmitting and receiving components, for example, a transmitter and a receiver. The server input/output interface 240 may include one or more input mechanisms (for example, a touch pad, a keypad, and the like), one or more output mechanisms (for example, a display, a speaker, and the like), or a combination thereof, or a combined input and output mechanism such as a touch screen.

In the example illustrated in FIG. 2, a single device is illustrated as including all components and the applications of the central management server 110. However, it should be understood that one or more of the components and one or more of the applications may be combined or divided into separate software, firmware, and/or hardware. Regardless of how they are combined or divided, these components and applications may be executed on the same computing device or may be distributed among different computing devices connected by one or more networks or other suitable communication means. In one example, all the components and applications of the central management server 110 are implemented in a cloud infrastructure accessible through several terminal devices, with the processor power located at a server location.

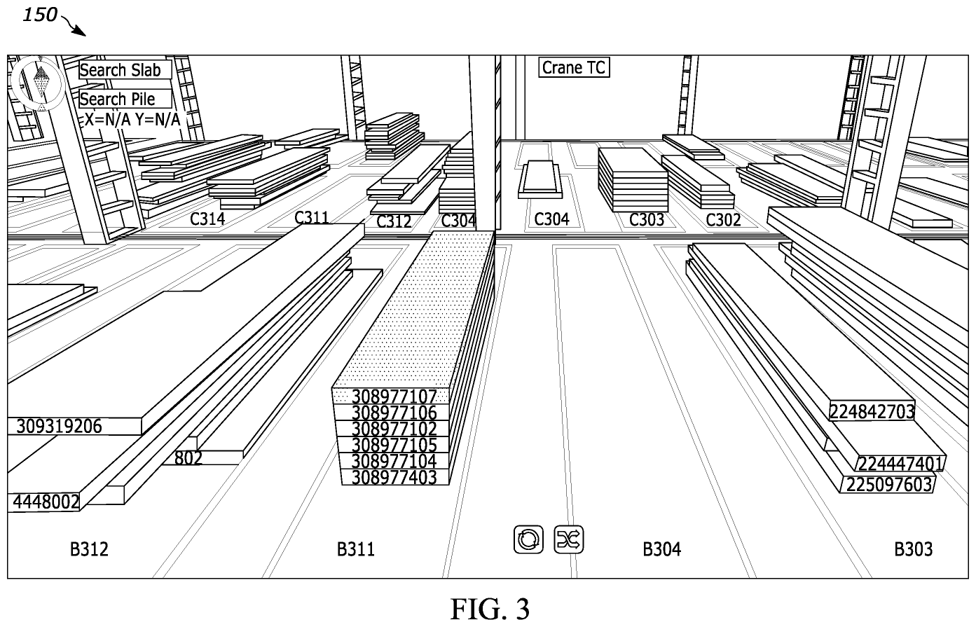

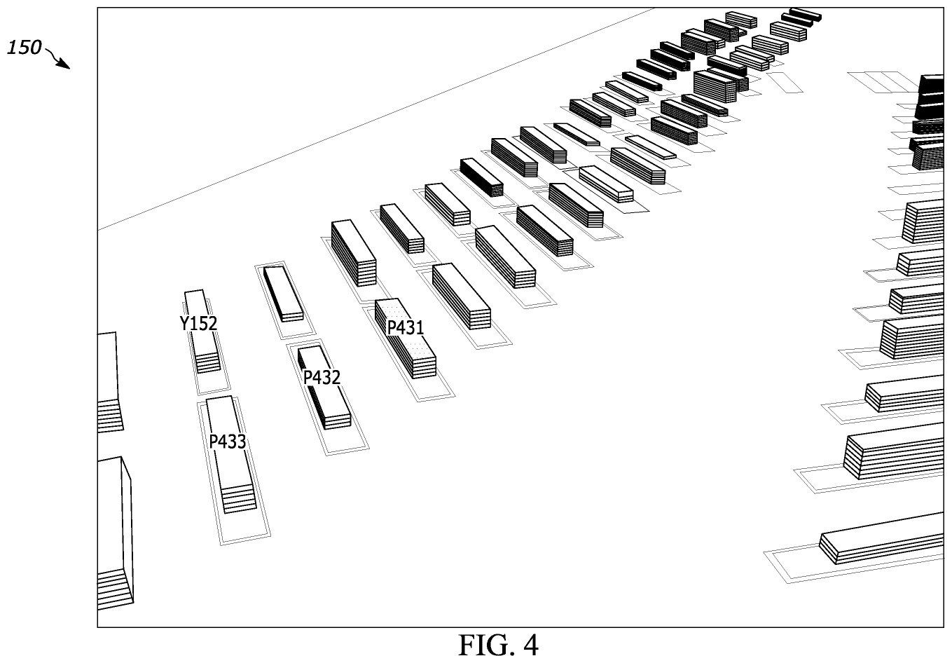

Referring to FIGS. 3 and 4, the first inventory location console 120A is provided at, for example, a lot within an indoor warehouse area 150 (shown in FIG. 3) and the second inventory location console 120B is provided at, for example, a lot within an outdoor storage area 160 (shown in FIG. 4). The indoor warehouse area 150 and the outdoor storage area 160 are divided into several lots, which may be numbered. Each area and each lot may be identified by corresponding identification data in the inventory database 275. Additionally, each lot may include certain electronic devices, for example, beacons, identification markers, image capturing devices, communication devices, and the like. Beacons may include, for example, radio frequency identification devices that emit identification information. Identification markers may include stamped data identifying the lot. Image capturing devices may include cameras to capture images of each lot or vehicles entering and exiting the lots. Communication devices include routers, repeaters, and the like that communicate with vehicles, drones, and the like and provide interaction information to the central management server 110 through the communication network 140. The central management server 110 communicates with the electronic devices provided at the inventory locations when the central management server 110 is communicating with the first inventory location console 120A and the second inventory location console 120B.

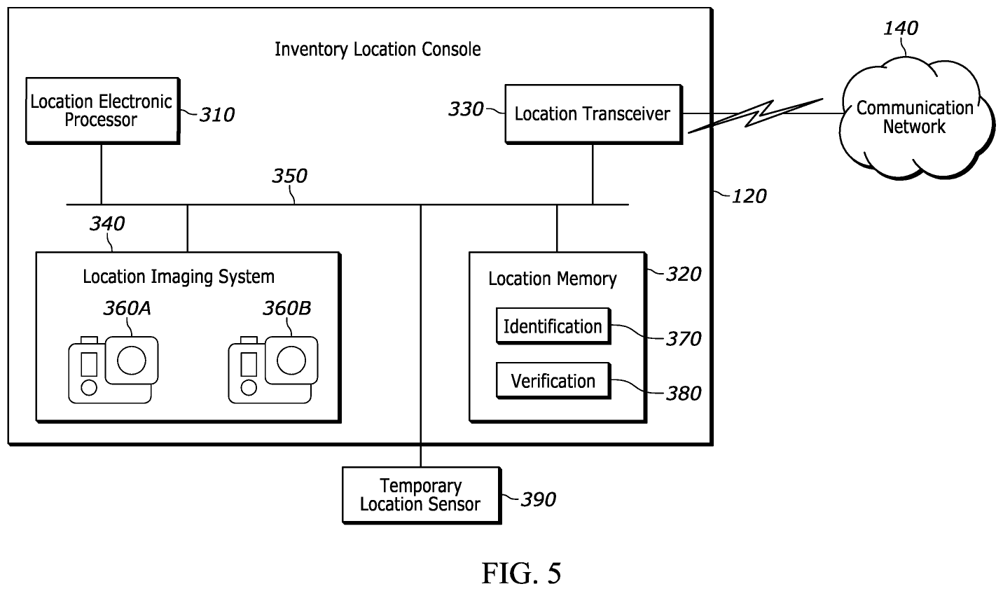

FIG. 5 is a simplified block diagram of an inventory location console 120. In the example illustrated, the inventory location console 120 includes a location electronic processor 310, a location memory 320, a location transceiver 330, and a location camera system 340 that communicate over one or more control and/or data buses (for example, a location communication bus 350). The location electronic processor 310, the location memory 320, and the location transceiver 330 may be implemented similar to the server electronic processor 210, the server memory 220, and the server transceiver 230 respectively as described above. The location transceiver 330 enables wired and/or wireless communication between the inventory location console 120 and the communication network 140.

The location camera system 340 includes a first location camera 360A and a second location camera 360B. The first location camera 360A is used for capturing identification information of one or more vehicles at the inventory locations. The first location camera 360A is mounted at a first elevation determined to be appropriate for capturing identification information of the vehicles and/or the inventory lots. For example, the first location camera 360A may be mounted at a higher elevation (e.g., higher than the vehicles) to capture identification information marked on a top surface of the vehicles. The second location camera 360B may be mounted at a second elevation to capture the transactions performed by the vehicles at the inventory lots. In some embodiments, rather that providing two or more location cameras 360, a single location camera 360 may be used for capturing both the identification information and the transactions. In other embodiments, the location camera system 340 also includes an identification information sensor, for example, a bar code sensor, an RFID sensor, and the like to identify the vehicles and uses the location camera 360 to capture transaction information. The location camera system 340 may be mounted to structure within the inventory location, for example, pillars, walls, poles, etc. In some embodiments, specialized poles or structures may be provided to mount the location camera system 340. A single location camera system 340 may be used to cover multiple lots within an inventory location. The location camera system 340 may identify the lots using markings provided on the lot (e.g., see FIGS. 3 and 4). In some embodiments, multiple location camera systems 340, for example, from multiple inventory location consoles 120 can be used to cover the same lot within the inventory location to receive additional image captures for the same transaction.

The location memory 320 may store several applications that are executed by the location electronic processor 310 to implement the functionality of the inventory location console 120. For example, the location memory 320 includes an identification application 370 and a verification application 380. The location electronic processor 310 executes the identification application 370 to identify a vehicle and/or a lot at the inventory location. The location electronic processor 310 executes the verification application 380 to capture images of a product transaction and transmit the images to the central management server 110.

The inventory location console 120 may be equipped with a temporary location sensor 390 removably coupled to the inventory location console 120. The temporary location sensor 390 may be configured to identify an X coordinate, a Y coordinate, and a Z coordinate of an inventory location within a coordinate system of a working area of the inventory location console 120. The coordinates may determined in relation to the location of the temporary location sensor 390 and/or the location of the inventory location console 120. The temporary location sensor is, for example, a global positioning system (GPS) sensor, a differential GPS (DGPS) system, a radar sensor, a laser distance sensor, a LiDAR sensor, and the like. The X coordinate, the Y coordinate, and the Z coordinate may be transmitted to the central management server 110 by the location transceiver 330 over the communication network 140. The X coordinate, the Y coordinate, and the Z coordinate may be used by the deep learning module 215 of the central management server 110 to train a location prediction application 217 during a training phase of the location prediction application 217. After the training phase is complete, the temporary location sensor 390 may be removed from the inventory location console 120.

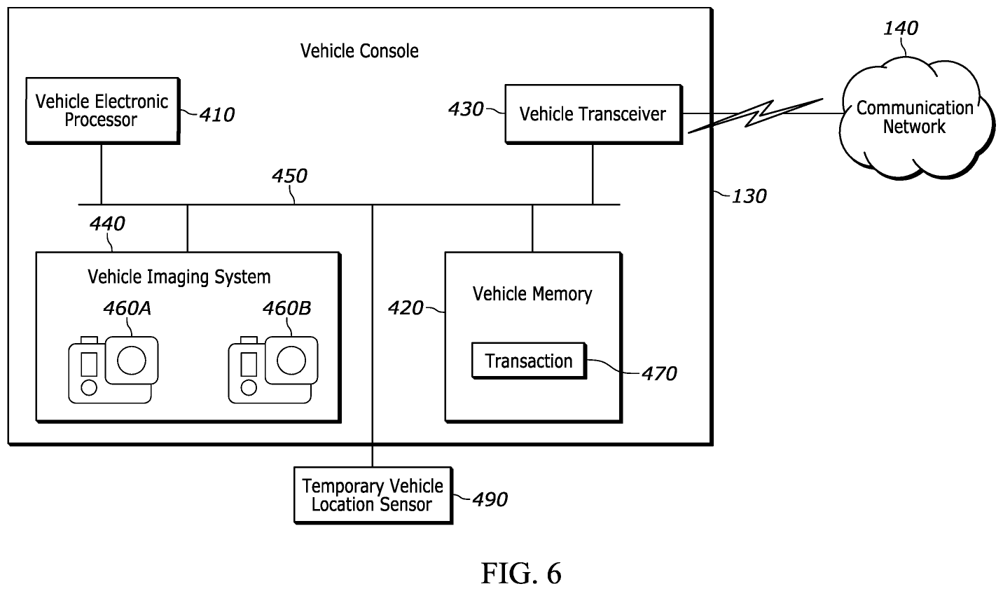

FIG. 6 is a simplified block diagram of a vehicle console 130. The vehicle console 130 is associated with a particular vehicle configured to handle an inventory item. It should be understood that although the vehicles of the vehicle consoles 130A, 130B, and 130C of FIG. 1 are illustrated as transport vans 130A, electric overhead transport (EOT) cranes 130B, rubber-tyre gantry (RTG) cranes 130C, it should be understood that the vehicle consoles 130 of the system 100 may be associated with any kind of industrial plant vehicle (for example, delivery vans, cranes, heavy duty lifters, haulers, trucks, forklifts, material handling robots, etc.), air-based vehicle (for example, drones), or some combination thereof. In the example illustrated, the vehicle console 130 includes a vehicle electronic processor 410, a vehicle memory 420, a vehicle transceiver 430, and a vehicle camera system 440 communicating over one or more control and/or data buses (for example, a vehicle communication bus 450). The vehicle electronic processor 410, the vehicle memory 420, and the vehicle transceiver 430 may be implemented similar to the server electronic processor 210, the server memory 220, and the server transceiver 230 respectively as described above. The vehicle transceiver 430 enables wired and/or wireless communication between the vehicle console 400 and the communication network 140.

The vehicle camera system 440 includes a first vehicle camera 460A and a second vehicle camera 460B. The first vehicle camera 460A is used for capturing identification information of lots at the inventory locations. The first vehicle camera 460A is mounted at a first location on the vehicle, for example, at a front of the vehicle to capture identification information marked on the lots of the inventory locations. The second vehicle camera 460B may be mounted at a second location to capture the transactions performed by the vehicles at the inventory lots. In some embodiments, rather that providing two or more vehicle cameras 460, a single vehicle camera 460 may be used for capturing both the identification information and the transactions. In other embodiments, the vehicle camera system 440 also includes an identification information sensor, for example, a bar code sensor, an RFID sensor, and the like to identify the lots and uses the vehicle camera 460 to capture transaction information. The vehicle camera system 440 is mounted to the body of the vehicle at appropriate locations as described above. The vehicles, as mentioned above, include, for example, delivery vans, cranes, heavy duty lifters, haulers, trucks, drones, and the like.

The vehicle memory 420 may store several applications that are executed by the vehicle electronic processor 410 to implement the functionality of the vehicle console 130. For example, the vehicle memory 420 includes a transaction application 470. The vehicle electronic processor 410 may execute the transaction application 470 to perform a transaction as described below with respect to method 700.

The vehicle console 130 may be equipped with a temporary vehicle location sensor 490 removably coupled to the vehicle console 130. The temporary vehicle location sensor 490 may be configured to identify an X coordinate, a Y coordinate, and a Z coordinate of an inventory location within a coordinate system of a working area of the vehicle console 130. The coordinates may determined in relation to the location of the temporary location sensor 390 and/or the location of the inventory location console 120. The temporary location sensor is, for example, a global positioning system (GPS) sensor, a differential GPS (DGPS) system, a radar sensor, a laser distance sensor, a LiDAR sensor, and the like. The X coordinate, the Y coordinate, and the Z coordinate may be transmitted to the central management server 110 by the vehicle transceiver 430 over the communication network 140. The X coordinate, the Y coordinate, and the Z coordinate may be used by the deep learning module 215 of the central management server 110 to train a location prediction application 217 during a training phase of the location prediction application 217. After the training phase is complete, the temporary vehicle location sensor 490 may be removed from the vehicle console 490.

FIG. 7 illustrates a flowchart of an example method 500 for computer-vision based inventory management. In the example illustrated, the method 500 includes receiving identification information for an inventory item (at block 510). In some embodiments, the inventory item is a product received or manufactured at the industrial plant. It should be noted that the terms “inventory item” and “product” are used herein interchangeably. For example, industrial plants receive raw material or other items for use at the industrial plant. Once the inventory item is received or manufactured, the inventory item is stamped with an identification mark or embedded with an identification device. In some embodiments, identification marks or other indicia on the inventory item already present when received at the industrial plant may also be used instead of stamping or embedding new identification information. In some embodiments, the inventory item is a product manufactured to customer specification at the industrial plant. Products at steel-making plants and other industrial plants are manufactured according to customer specifications. Specifically, the composition, shape, size, and the like are specified by the customer and the product is manufactured according to the applicable specification at the industrial plant. Once the product is manufactured, the product is stamped with an identification mark (e.g., a bar code, a number, or the like) or embedded with an identification device (e.g., an RFID tag, or the like). The identification information associated with the identification mark of the identification device may be generated by the central management server 110. In some embodiments, the identification information is generated by a different entity or device and provided to the central management server 110.

The method 500 includes populating inventory information for the inventory item based on identification information (at block 520). The central management server 110 may retrieve the inventory information from the inventory database 275. In some embodiments, the inventory information may be manually populated by a user of the central management server 110. The inventory information includes, for example, composition of the product, shape/size of the product, manufacturing location of the product, intermediate storage locations of the product, delivery location of the product, and the like.

The method 500 also includes moving the inventory item between two or more storage locations (at block 530). The two or more locations may include, for example, a manufactured location of the inventory item (for example, when the inventory item is a product manufactured at the industrial plant), a received location of the inventory item, one or more intermediate storage locations, and a delivery location (for example, for customer delivery). In some embodiments, the two or more locations may include locations within the industrial plant or may include locations within and outside the industrial plant. For example, the two or more locations include a warehouse, an intermodal yard, a port, and the like. The central management server 110 may execute the dispatch vehicle application to control or provide instructions to the one or more vehicles to move the inventory item between the different locations. The method 700 (FIG. 9) provides an example of moving the product between different location. Moving the inventory item includes, for example, a transportation vehicle (e.g., trucks, vans, cranes, or the like) picking up the inventory item from a first location and dropping off the inventory item at a second location. Moving the inventory item may also include using a loading vehicle (e.g., rubber tire or track gantry crane) loading the inventory item on to a delivery vehicle (e.g., a delivery train, delivery container, and the like). Pick-up, drop-off, and loading may include operating a handling system/device (for example, a forklift, a crane arm, a mechanical arm, a crane hook, and/or the like) for picking up and moving a product. Pick-up, drop-off, and loading may be referred to as inventory item transactions for the purpose of this application.

The method 500 also includes verifying one or more inventory item transactions at each stage of the moving/handling of the inventory item (at block 540). The central management server 110 may execute the verification application 290 to verify an inventory item transaction. The central management server 110 instructs the inventory location consoles 120 and/or vehicle consoles 130 to capture images of inventory item transactions. For example, when a vehicle is picking up inventory from an inventory storage location, the images or video of the product transaction may be captured by both the inventory location consoles 120 and the vehicle consoles 130. The central management server 110 receives the images captured by the inventory location consoles 120 and the vehicle consoles 130 and verifies that the inventory item transaction was performed correctly. The central management server 110 processes the images using image processing techniques to determine the actions performed (e.g., pick-up, drop-off, or loading) and the change of inventory at the inventory storage location. The central management server 110 may identify, from the images, a plurality of images that each depict a different stage of the inventory item transaction and determine, based on each of the plurality of images, inventory item information regarding a location of a stage of the transaction, a vehicle performing the transaction, and an amount of the product. For example, the central management server 110 may process the images to determine the change in height or volume at the inventory storage location to determine the amount of product move from or to the inventor storage location.

The method 500 also includes performing chain of custody corrections (at block 550). An inconsistency within the transaction of a product may occur, for example, when the inventory is stored at incorrect locations or the inventory is repurposed for a different customer. In response to an inconsistency within the transaction of the product in verifying the transaction based on the image data, the central management server 110 may perform a chain of custody correction by dispatching a vehicle to correct the chain of custody. Correcting the chain of custody may include moving the inventory to the correct intermediate storage location or the correct delivery location. The central management server 110 may instruct and/or control the vehicles to move the inventory to the correct final location and to verify the product transaction. Correcting the chain of custody may also include updating or correcting the current location of the inventory items to the location where the inventory items are currently stored.

The method 500 also includes generating (or updating) a chain of custody record for the inventory item (at block 560). Generating the chain of custody record may include retrieving the inventory item information, received or manufactured location, the intermediate storage locations, and data relating to the inventory item transactions, and the like. For example, the central management server 110 may retrieve images of inventory item transactions, insert timestamps for the inventory item transactions to provide a detailed record of how the inventory item was handled from manufacturing to delivery and may provide identification information along with images regarding each vehicle and location involved with the inventory item.

FIG. 8 is a flowchart of an example method 600 for verifying inventory item transaction at an inventory location. In the example illustrated, the method 600 includes identifying, using an electronic processor 310, 410, a vehicle performing an inventory item transaction (at block 610). The inventory location console 120 may use the location camera system 340 to capture an image of the identification information of the vehicle. In some embodiments, the inventory location console 120 may communicate with the vehicle console 130 of the vehicle to determine the identification information of the vehicle. In some embodiments, the vehicle may be identified based on the dispatch from the central management server 110 to perform an inventory transaction.

The method 600 also includes identifying, using the electronic processor 310, 410, an inventory storage location associated with the inventory item transaction (at block 620). The inventory location console 120 uses the location camera system 340 to capture an image of where the vehicle is performing an inventory item transaction to determine the identification information of the inventory storage location (for example, the images shown in FIGS. 3 and 4). The inventory location console 120 may process the image to determine the identification information or may provide the image to the central management server 110 for processing. In some embodiments, the vehicle location console 130 uses vehicle camera system 340 to capture an image of where the vehicle is performing an inventory item transaction to determine the identification information of the inventory storage location.

The method 600 also includes capturing, using a camera system, images of the inventory item transaction (at block 630). The location electronic processor 310 may control the location camera system 340 to capture an image at the beginning of the inventory item transaction and at the end of the transaction. In some embodiments, the location electronic processor 310 may control the location camera system 340 to capture a video of the inventory item transaction. Alternatively or additionally, the vehicle electronic processor 410 may control the vehicle camera system 440 to capture an image at the beginning of the inventory item transaction and at the end of the transaction.

The method 600 also includes providing, using a transceiver, the images of the inventory item transaction to the central management server 110 (at block 640). The inventory location console 120 or the vehicle console 130 captures and transmits the images or videos of the transaction to the central management server 110. In some embodiments, the images may be transmitted in real-time or near real-time. In other embodiments, the images may be transmitted at regular intervals or at a pre-determined time.

The method 600 also includes processing, using the electronic processor 210, the images for inventory item transaction verification (at block 650). The central management server 110 uses image processing techniques to determine the actions performed at the inventory location (e.g., pick-up, drop-off, loading, or the like). For example, the central management server 110 may use image processing techniques to determine a position of the handling device 435 of the vehicle console 130 relative to the inventory at the inventory storage location. The central management server 110 may also process the images to determine the change in height or volume of the inventory at the inventory storage location. Based on the change in height or volume, the server electronic processor 210 may determine the amount of inventory that was picked up, dropped off, or loaded at the inventory storage location. The server electronic processor 210 may compare the actual change in inventory with the expected change in inventory and provide an alert when a mismatch is detected. This mismatch may be corrected by performing a chain of custody correction as discussed above.

In some embodiments, the method 600 may also include processing images or group of images to automatically calibrate the verification system 290. The server electronic processor 210 may process the images received from the inventory location and the vehicles to calibrate the locations stored in the verification systems. Calibration may be used to initialize the locations, initialize the dimensions as perceived through a camera, correct the locations, correct the dimensions as perceived through a camera, and the like. In some embodiments, the calibration may be performed using manual input. For example, after initialization, users of the system may adjust the settings of the verification systems to correct the locations or camera perception using manual input at the central management server 110. In some embodiments, the images may be used as an input to neural network modules to automatically identify and correct inventory locations and camera perceptions based on the images.

FIG. 9 illustrates a flowchart of an example method 700 for vehicle dispatch to inventory location. In the example illustrated, the method 700 includes receiving, using the vehicle transceiver 430, inventory item transaction information (at block 710). The product transaction information is received from the central management server 110. In some embodiments, the inventory item transaction information may be sent to an operator device (e.g., smartphone). The operator then drives the vehicle and performs the transactions according to the inventory item transaction information. Alternatively, the vehicle may be an autonomous or semi-autonomous vehicle that is configured to automatically perform the inventory item transaction according to the instructions received from the central management server 110.

The method 700 also includes operating the vehicle in a predetermined route to the inventory location (at block 720). The route may be received from the central management server 110. In some embodiments, the central management server 110 provides the destination, while the vehicle console 130 automatically determines the route to the destination. The vehicle may be manually operated to the destination by the operator. In other embodiments, the vehicle is an autonomous vehicle that is controlled by the vehicle electronic processor 410 to drive in the predetermined route to the inventory location. In these embodiments, the vehicle electronic processor 410 may use the location prediction application 217 to guide the vehicle between the starting point and ending point of the predetermined route.

The method 700 also includes identifying, using the electronic processor 310, 410, the inventory location associated with the inventory item transaction (at block 730). The vehicle console 130 may use the vehicle camera system 440 to determine the correct lot at the inventory location for the inventory item transaction. In one example, the location prediction application 217 may be used to determine the inventory location. The vehicle console 130 determines the lot using the identification markers provided on the lot and guides the vehicle to the lot to perform the inventory item transaction.

The method 700 also includes performing the inventory item transaction (at block 740). As discussed above, the inventory item transaction includes picking up inventory from an inventory storage location, dropping off inventory at an inventory storage location, or loading inventory on to a delivery vehicle. The inventory item transaction may be performed automatically by the vehicle. For example, the central management server 110 may be configured to provide one or more commands to the vehicle console 130 to operate a handling device of the respective vehicle. The central management server 110, for example, may determine a position of the handling device of a vehicle based on captured image data (for example, from one or more of the inventory location consoles 120 and/or one or more of the vehicle consoles 130) and provide commands based on the determined position. In some embodiments, the vehicle may be controlled by an operator to perform the inventory item transaction.

The method 700 also includes capturing images of the inventory item transaction (at block 750). The vehicle console 130 starts capturing images using the vehicle camera system 440 when the inventory item transaction has begun. The vehicle console 130 may also provide an indication to the inventory location console 120 such that the inventory location console 120 may also capture images of the inventory item transaction. The vehicle electronic processor 410 controls the vehicle camera system 440 to capture an image at the beginning of the inventory item transaction and the at the end of the transaction. In some embodiments, the vehicle electronic processor 410 controls the vehicle camera system 440 to capture a video of the inventory item transaction.

The method 700 also includes providing, using the transceiver, the images of the inventory item transaction to the central management server 110 (at block 760). The vehicle console 130 captures and transmits the images or videos of the transaction to the central management server 110. In some embodiments, the images may be transmitted in real-time or near real-time. In other embodiments, the images may be transmitted at regular intervals or at a pre-determined time. The method 700 may be repeated for each inventory item transaction.

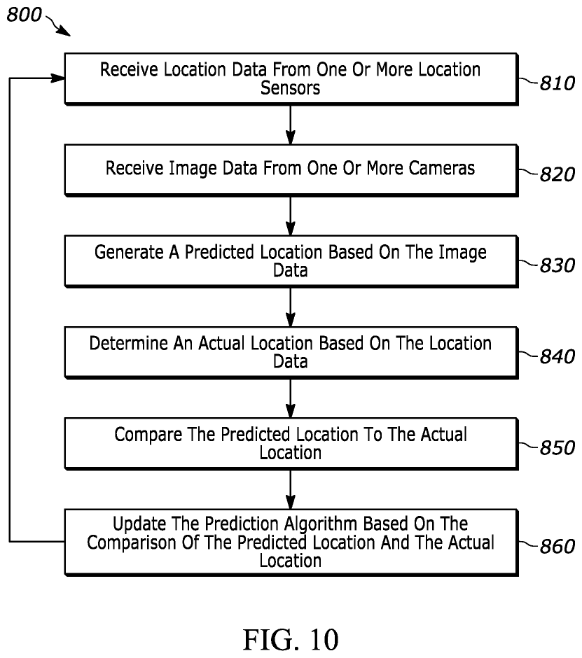

FIG. 10 illustrates a flow chart of an example method 800 to train a machine-learning-based location prediction application 217 executed by the deep learning module 215 while in a training phase. The deep learning module 215 can be considered as including one or more inputs and one or more outputs. In the examples described in this application, the deep learning module 215 includes two inputs and one output during the training phase and includes one input and one output during the execution phase. The deep learning module 215 includes a prediction engine to predict the output based on the input. During the training phase, the prediction is compared to an actual value to determine the accuracy of the prediction.

In the example illustrated, the method 800 includes receiving, by the deep learning module 215, location data (at block 810). The location data is received from one or more inventory location consoles 120 or vehicle consoles 130 (in particular, from one or more location sensors thereof). For example, the location data is received from the temporary location sensors 390 and 490. The method 800 also includes receiving, by the deep learning module 215, image data from one or more cameras (for example, of the imaging systems 340, 440) of an inventory location (at block 820). The image of the inventory location may contain one or more inventory items or vehicles. The image of the inventory location is received from one or more inventory location consoles 120 or vehicle consoles 130. In some embodiments, the images may be transmitted in real-time or near real-time. In other embodiments, the images may be transmitted at regular intervals or at a pre-determined time. The step (at block 820) may be repeated for each inventory item transaction.

The method 800 also includes generating, by the deep learning module 215 using the location prediction application 217, a predicted location of an inventory item, transaction, an inventory location, a vehicle handling the transaction, a handling device of a vehicle, or the like based on the image data (at block 830). In some embodiments, the location is based on an absolute position value with respect to the working area of the inventory management system 100. In other embodiments, the location is based on a storage location within the working area of the inventory management system 100 with respect to an inventory location console 120. The images include, for example, physical markings provided at the inventory locations or on the vehicles. The prediction engine of the deep learning module 215 may analyze the markings to determine and predict a location based on the images. For example, in some embodiments, the deep learning module 215 identifies a location of a physical marker within a first image and a location of the physical marker within a second image. The deep learning module 215 may then determine an exact location (for example, of a vehicle) based on a difference between a number of pixels between an edge of the first image and the location of the physical marker within the first image and a number of pixels between a same edge of the second image and the location of the physical marker within the second image.

The method 800 also includes determining, with the deep learning module 215, an actual location based on the location data (at block 840). For example, the actual location data may be determined using traditional methods and using the temporary sensors 390, 490 provided at the inventory locations and vehicles. Traditional methods include triangulation, distance measurement, and the like employed by one or more electronic processors described above. In some embodiments, the location data may also be determined using user provided information. In some embodiments, the actual location is confirmed based on data from an additional location sensor (not shown) different from the temporary sensors 390, 490.

The method 800 also includes comparing, by the deep learning module 215, the predicted location with the actual location of the inventory item, transaction, an inventory location, a vehicle handling the transaction, a handling device of a vehicle, or the like (at block 850). The deep learning module 215 may use this comparison to determine an error associated with the predicted location. The method 800 also includes updating, by the deep learning module 215, the location prediction application 217 based on the comparison of the predicted location with the actual location (at block 860). The deep learning module 215 may adjust at least one parameter associated with the location prediction application 217 to increase the accuracy of the predicted location. For example, if an X coordinate of the predicted location is higher than an X coordinate of the actual location, the deep learning module 215 may alter the location prediction application 217 to lower a future X coordinate of a future predicted location. If the deep learning module 215 remains in the training phase at the end of the method 800, the method 800 returns to block 810. In some embodiments, the method 800 may also include determining the location prediction application 217 is sufficiently accurate for deployment. For example, the electronic processor 210 may determine whether the location prediction is within a tolerance level for a predetermined number of repeated projects before deploying the location prediction application 217 to determine a location.

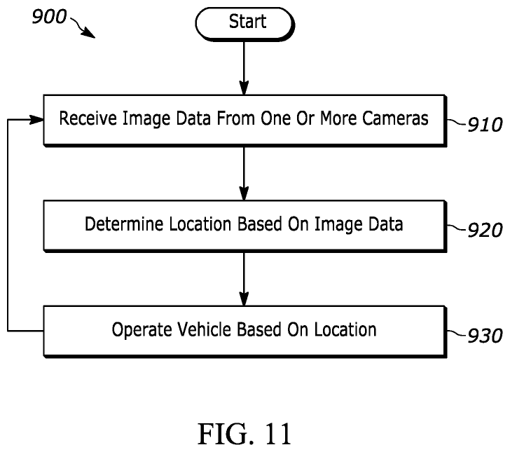

FIG. 11 illustrates a flow chart of an example method 900 for enabling (i.e., deploying) and using a location prediction application 217 of a deep learning module 215. The method 900 includes placing one or more temporary location sensors 390 on an inventory location console 120. The method 900 receiving, by the deep learning module 215, image data from one or more cameras (for example, of the imaging systems 340, 440) of an inventory location (at block 910). The image of the inventory location may contain one or more inventory items or vehicles. The image of the inventory location is received from one or more inventory location consoles 120 or vehicle consoles 130. In some embodiments, the images may be transmitted in real-time or near real-time. In other embodiments, the images may be transmitted at regular intervals or at a pre-determined time.

The method 900 also include determining, using the deep learning module 215, a location based on the image data (at block 920). As discussed above in regard to the method 800 of FIG. 10, the deep learning module 215 generates a prediction using the image data received from the one or more imaging devices. Specifically, the deep learning module 215 analyzes the images to detect physical markers at a location within the images. The particular location may then be determined based on the markers. In other embodiments, the deep learning module 215 uses other methods to determine the location based on the images received.

The method 900 further includes operating, using the electronic processor 210, a vehicle based on the determined location (at block 930). For example, the electronic processor 210 provides commands to autonomously operate the EOT cranes or other autonomous and semi-autonomous vehicles in the steel-plant. In other embodiments, other tasks including operation of the vehicles are performed based on the determined location. For example, an inventory pick-up, an inventory drop-off, and the like may be performed based on the determined location.

In some embodiments, the electronic processor 210 executes the inventory management application 280 to determine inventory levels/an amount of inventory item based on image data (for example, as described above in regard to the method 600 of FIG. 8). The electronic processor 210 retrieves inventory data from the inventory database 275 to determine the current inventory levels for one or more inventory items handled at the industrial plant. These inventory levels may be provided in the inventory item chain of custody record. Accordingly, users may track inventory levels after each inventory item transaction. Users may also retrieve the current inventory levels at any time using the inventory management application 280.

In some embodiments, the chain of custody record is also generated for a specific location. Based on the inventory and vehicle tracking at a location, the inventory management application 280 creates a chain of custody record for the inventory location. The chain of custody record includes information involving the inventory item transactions performed at the inventory location, vehicles that visited and performed actions at the inventory location and the like. Specifically, the electronic processor 210 processes the images obtained from the inventory location cameras 360 and/or the vehicle cameras 460 to determine the transactions and vehicles at the inventory location. These transactions and vehicle information at the inventory location is then timestamped and presented in the chain of custody record.

In some embodiments, the inventory management application 280 also tracks equipment availability. The equipment may be certain inventory items or vehicles. The electronic processor 210 may also track whether equipment is currently functioning or under maintenance based on manual input or based on information received directly from the equipment or from one or more of the cameras. The electronic processor 210 may then dispatch the equipment based on availability, functionality, and the like. The inventory management application 280 may also include operating one or more of the vehicles (and/or handling devices thereof) to avoid collisions with other vehicles and/or inventory items based on image data from the inventory location consoles 120 and/or the vehicle consoles 130 and the location of the vehicle(s).

In some embodiments, the inventory management application 280 also tracks space availability at inventory locations. The electronic processor 210 may capture images of the inventory locations using inventory location cameras 360 and/or vehicle cameras 460 to determine the current inventory at a location. The inventory database 285 stores an inventory capacity of a location. The electronic processor 210 determines the space availability at an inventory location based on the inventory capacity and the current inventory at a location. The inventory management application 280 is executed to determine optimum placement of inventory based on the characteristic of the inventory location (e.g., indoor, outdoor, dimensions, and the like), characteristic of the inventory item (e.g., dimensions, weather sensitivity, and the like), and the space availability at inventory locations. The inventory management application 280 may be executed to determine the space availability of one or more locations at the industrial plant.

Thus, embodiments provide, among other things, a computer-vision based inventory system at industrial plants.

What is claimed is:

1. An inventory management system for a manufacturing facility, the system including:
a central management server including
a camera system;
a transceiver;
an electronic processor configured to
receive, via the transceiver, identification information for a product,
identify an initial location of the product within the facility and a target location to move the product to within the facility based on the identification information,
perform, via a vehicle configured to handle the product, a transaction of the product between the initial location and the target location based on image data from the camera system,
verify the transaction based on image data from the camera system, and
generate, based on the image data from the camera system, a chain of custody record for the product.

2. The system of claim 1, wherein the one or more vehicles include at least one selected from a group consisting of a land-based vehicle, an air-based vehicle, and a crane system.

3. The system of claim 1, wherein the electronic processor is further configured to operate a handling device of the vehicle, wherein operating the handling device includes determining a position of the handling device based on the image data from the camera system.

4. The system of claim 1, wherein the electronic processor is further configured to, in verifying the transaction, determine an amount of product handled by the vehicle during the transaction based on the image data.

5. The system of claim 1, wherein the electronic processor is further configured to, in response to determining an inconsistency within the transaction of the product in verifying the transaction based on the image data, performing a chain of custody correction, wherein performing the chain of custody correction includes moving the inventory to a correct final location.

6. The system of claim 1, wherein performing and verifying the transaction of the product includes
identifying, within the image data, a plurality of images, each of the plurality of images depicting a different stage of the transaction,
determining, based on each of the plurality of images, inventory item information regarding at least one selected from the group consisting of a location of a stage of the transaction, a vehicle performing the transaction, and an amount of the product, and
storing the inventory item information as part of the chain of custody record.

7. The system of claim 6, wherein the electronic processor determines the location depicted within the image based on a physical marker within an area depicted in at least one of the plurality of images.

8. The system of claim 7, wherein performing and verifying the transaction includes
identifying a location of the physical marker within a first image of the plurality of images,
identifying a location of the physical marker within a second image of the plurality of images, and
determining an exact location of the vehicle based on a difference between a number of pixels between an edge of the first image and the location of the physical marker within the first image and a number of pixels between a same edge of the second image and the location of the physical marker within the second image.

9. A method for training a location prediction application of a deep learning module, the method including:
receiving, at the deep learning module, location data from one or more location sensors; and
receiving, at the deep learning module, image data from a camera system;
generating, via the location prediction application, a predicted location of an inventory item or transaction based on the image data;
determining an actual location of the inventory item or transaction of the inventory item based on the location data;
comparing the predicted location and the actual location; and
updating the location prediction application based on the comparison of the predicted location and the actual location.

10. The method of claim 9, wherein the one or more location sensors include at least one selected from a group consisting of a radar sensor, an infrared sensor, a lidar sensor, and a differential global positioning system.

11. The method of claim 9, the method further comprising confirming the actual location of the inventory item based on data from an additional location sensor different from the one or more location sensors.

12. The method of claim 9, the method further comprising determining an amount of the inventory item based on the image data.

13. A method of managing inventory at a manufacturing facility, the method comprising:
receiving, via a transceiver, identification information for a product;
identifying an initial location of the product within the facility and a target location to move the product to within the facility based on the identification information;
performing, via a vehicle configured to handle the product, a transaction of the product between the initial location and the target location based on image data from a camera system;
verifying the transaction based on image data from the camera system; and
generating, based on the image data from the camera system, a chain of custody record for the product.

14. The method of claim 13, further comprising operating a handling device of the vehicle, wherein operating the handling device includes determining a position of the handling device based on the image data from the camera system.

15. The method of claim 13, wherein verifying the transaction further comprises determining an amount of product handled by the vehicle during the transaction based on the image data.

16. The method of claim 13, further comprising in response to determining an inconsistency within the transaction of the product in verifying the transaction based on the image data, performing a chain of custody correction, wherein performing the chain of custody correction includes moving the inventory to a correct final location.

17. The method of claim 13, wherein performing and verifying the transaction of the product includes
identifying, within the image data, a plurality of images, each of the plurality of images depicting a different stage of the transaction,
determining, based on each of the plurality of images, inventory item information regarding at least one selected from the group consisting of a location of a stage of the transaction, a vehicle performing the transaction, and an amount of the product, and
storing the inventory item information as part of the chain of custody record.

18. The method of claim 17, further comprising determining the location depicted within the image based on a physical marker within an area depicted in at least one of the plurality of images.

19. The method of claim 17, wherein performing and verifying the transaction includes
identifying a location of the physical marker within a first image of the plurality of images,
identifying a location of the physical marker within a second image of the plurality of images, and
determining an exact location of the vehicle based on a difference between a number of pixels between an edge of the first image and the location of the physical marker within the first image and a number of pixels between a same edge of the second image and the location of the physical marker within the second image.

20. The method of claim 17 further comprising:
receiving, at a deep learning module, location data from one or more location sensors; and
receiving, at the deep learning module, the image data;
generating, via a location prediction application, a predicted location of an inventory item or transaction based on the image data;
determining an actual location of the inventory item or transaction of the inventory item based on the location data;
comparing the predicted location and the actual location; and
updating the location prediction application based on the comparison of the predicted location and the actual location.
